(19) United States
(12) Patent Application Publication
(10) Pub. No.: US 2015/0326844 A1
(43) Pub. Date: Nov. 12, 2015

(54) QUANTIFIABLE STEREOSCOPIC THREE-DIMENSIONAL VIDEO EVALUATION METHODOLOGY

(71) Applicants: Brent M. Celmins, Portland, OR (US); Philip J. Corriveau, Carlton, OR (US); Tordra J. Schlieski, Hillsboro, OR (US); Audrey C. Younkin, Beaverton, OR (US)

(72) Inventors: Brent M. Celmins, Portland, OR (US); Philip J. Corriveau, Carlton, OR (US); Tordra J. Schlieski, Hillsboro, OR (US); Audrey C. Younkin, Beaverton, OR (US)

(21) Appl. No.: 13/977,534

(22) PCT Filed: Dec. 22, 2011
(86) PCT No.: PCT/US2011/066954

§ 371 Date: Sep. 16, 2013

(51) Int. Cl. H04N 13/00; H04N 17/00

(52) U.S. Cl. CPC H04N 13/0007; H04N 17/004; H04N 13/0059; H04N 2013/0074; H04N 2013/0077

(57) ABSTRACT

A methodology for quantifiable three-dimensional video evaluation is described. In one example, a graphics processor analyzes the video for a plurality of factors in a plurality of categories that affect the presentation of a video. A general processor compiles the scores for each factor into scores for a category and compiles scores for the category into an overall three-dimensional score, and an external interface presents the scores for evaluation.

### BACKGROUND

Broadcasters are moving quickly to bring S3D (Stereoscopic Three-Dimension Video) into homes via live delivery and distribution of events, such as sports. Market forecasts predict over 80 million annual unit sales of S3D HDTV sets by the year 2015. Manufacturers and content producers are rushing to fill stores with products and services for end user consumption. Because there were no live S3D broadcasts before 2009, S3D is a nascent broadcasting technique with great potential to penetrate the market and compensate for the lack of pre-recorded S3D material.

S3D uptake has been slow for a lack of quality content. Live S3D broadcasts are problematic for at least two major reasons. First live broadcasts, while planned, are not controlled as effectively as other forms of broadcasting (movies, TV shows, etc.). The integrity of S3D live broadcasts can be threatened due to these unpredictable variables and yield poor consumer experiences. Second, problems that may be insignificant in a comparable live 2D broadcast can become exacerbated in S3D, creating discomfort, confusion, and degraded quality for the viewers. In worst case scenarios, the problem can ruin an entire experience for viewers.

Currently, on field camera operators, graphics designers, editors, producers, directors, and other broadcasting experts do not have quantifiable metrics to aid them in the evaluation and improvement of their S3D content creation.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is diagram of a real presentation of evaluation categories according to an embodiment of the invention.

FIG. 2 is diagram of a presentation of quality metrics for S3D video according to an embodiment of the invention.

FIG. 3 is diagram of a presentation of a mean comfort score for S3D video according to an embodiment of the invention.

FIG. 4 is diagram of a presentation of a mean video score for S3D video according to an embodiment of the invention.

FIG. 5 is diagram of a presentation of a mean ecosystem score for S3D video according to an embodiment of the invention.

FIG. 6 is diagram of a presentation of a mean broadcast score for S3D video according to an embodiment of the invention.

FIG. 7 is block diagram of a video system suitable for implementing processes of the present disclosure according to an embodiment of the invention.

FIG. 8 is a process flow diagram of analyzing the quality of the video according to an embodiment of the invention.

FIG. 9 is a diagram of a broadcast infrastructure suitable implementing processes of the present disclosure according to an embodiment of the invention.

### DETAILED DESCRIPTION

Embodiments of the present invention can play a significant role in guiding the development of products and content for S3D. Quality of Experience metrics that are embedded in IA (Intel Architecture) or other types of processors can provide a base language and measurement system Embodiments of the present invention provide a quantifiable set of clearly defined metrics that may be used to grade live S3D broadcasts. A trained expert can use this methodology in conjunction with appropriate members of a broadcast team to improve a live S3D experience.

Content producers and exhibitors along all points of the production and distribution chain may analyze the potential problems in a live S3D broadcast in the context of categorized component parts. This better identifies where the problem within the live S3D broadcast is occurring to help better drive potentially adaptable and scalable solutions to improve live S3D broadcasts. In the event that an issue is occurring outside of a specific user's scope of production or distribution, embodiments of the present invention allow a user to communicate, in quantifiable terms, to production and distribution partners about measured problems.

For example, broadcast category may be defined so that problems that are occurring within the broadcast category are issues that are occurring primarily in the field of production. The results from this methodology informs content producers that the solution to this problem needs to be addressed with the teams in the field, capturing the content or feeding the content out from the site. Conversely, a video category may be defined so that problems reported within a video category are more likely to be occurring within the display (at the point of display, rather than the point of field production). While there is some crossover across the categories (for example, brightness appears in both categories), the method allows teams working in the field to communicate with teams from the exhibition side using the same procedures and identical nomenclature. Then, those working within the production-distribution chain can determine at which point the problem is occurring and drive a relevant solution.

In other words, the described embodiments of the invention provide a quantifiable set of metrics and solid methodology that can be used to effectively evaluate broadcasts, and allow content producers to compare experiences across types of events using the same set of baseline metrics. It takes the language of S3D evaluation and adds a subjective meaning (adjectives) scale so evaluators and producers can decide on proper courses of action based on the same set of descriptor information.

The described quantified grading scale makes this evaluation system unique. The problems and issues within S3D have basic definitions, but none of the currently standardized evaluation systems are able to quantify the problems in a way that creates meaningful results as a basis for comparison across broadcasts.

The described techniques may be divided into three major categories

1. Quality Category: quantifiable metrics defining the quality of the S3D broadcast aggregated along all points in the production chain. The Quality Category is divided into three subcategories:

a. Video Sub-Category: Problems with the image on the local display or screen.

b. Ecosystem Sub-Category: issues related to the infrastructure and equipment used to broadcast the event along all parts of the production & distribution chain (from capture to delivery but not display)

c. Broadcast Sub-Category: issues that are directly related to production decisions in the field (decisions that drive live adaptable changes)

2. S3D Integrity Category: Pass/Fail metrics measuring the integrity of issues present exclusively in the S3D broadcast space. These features do not exist in the 2D space, and are either successes or failures, thus are measured using a dichotomous coding mechanism.

3. Comfort Categories: quantifiable metrics describing the physical comfort level during viewers' S3D experiences.

The Quality and Comfort categories may be evaluated using video and image analysis hardware or by a technical expert on a scale (e.g. a scale from 1-5). The data can then be statistically analyzed across the overall broadcast, several broadcasts, across several viewers, as well as collapsed across the individual categories. These different approaches allow one to arrive at a numerical score as a quantitative evaluation of the broadcast and its components. Table 1 provides a scale that might be used to score content whether by hardware or a technical expert. Table 1 also provides adjective that can be associated with any particular numerical score.

TABLE 1

| Score | Quality Description | Comfort Description |
|---|---|---|
| 5 | Excellent; No visual artifacts | The same as when I |
| | Imperceptible; Video is playing in real-time and there is no | arrived |
| | stuttering or pausing. | |
| 4 | Good; Slight visual artifacts | Somewhat different |
| | Perceptible but not annoying; Minimal stuttering or pausing | compared to when I |
| | | arrived but not concerning |
| 3 | Fair; Noticeable artifacts | Somewhat uncomfortable |
| | Perceptible and slightly annoying; Some stuttering or pausing but | compared to when I |
| | still smooth enough that it was acceptable and you would continue | arrived |
| | to watch | |
| 2 | Poor; Majority of content contains artifacts | Uncomfortable compared |
| | Perceptible and annoying; Many stutters or pausing and you would | to when I arrived |
| | continue to watch only if the content was very important or | |
| | compelling to you | |
| 1 | Bad; Too many artifacts, would not continue to watch | Very uncomfortable |
| | Perceptible and very annoying; So many stutters or pausing that | compared to when I |
| | you would no longer watch or listen | arrived |

The categories are presented in more detail in Table 2.

TABLE 2

| Comfort | Quality | S3D Integrity |
|---|---|---|
| Eye Strain | Video: Ghosting | Sampling Time Offset |
| Dizzying Motion | Video: Resolution | Window Violation |
| Nausea | Video: Brightness | Vertical Misalignment |
| | Ecosystem: Broadcast Breaks | Horizontal |
| | | Misalignment |
| | Ecosystem Resolution | Rotational Error |
| | Broadcast: Invasive Objects | |
| | Broadcast: Disappearances | |
| | Broadcast: Graphic Focus | |
| | Broadcast: Graphic Placement | |
| | Broadcast: Brightness | |

Each of these factors can be characterized and described and the scores can be compiled in various ways. The factors can be described as follows:

Comfort Category

Eye Strain: Viewer's eyes/occipital lobes become tired or start to ache during exposure to 3D images.

Dizzying Motion: Camera moves too quickly for the viewer to orient himself, and the viewer becomes dizzy.

Nausea: The viewer becomes nauseous during exposure to 3D images.

Quality Category

Video Sub-Category

Ghosting: Text or objects have a visible shadow or “ghost”

Resolution: Resolution level of broadcast (Full HD content is 1920×1080 resolution)

Brightness: Level of visible light of the broadcast to the viewer (e.g. nit value)

Ecosystem Sub-Category

Broadcast Breaks: Breakdown in the broadcast stream caused by a glitch in the field, with the transmission, or with the distribution that may include, pixilation, color phasing, cut to black, freeze frames, etc.

Resolution: Resolution level of broadcast. Broadcast 3D sends 2 images in the same space as a single HD image and so is noticeably lower resolution than HDTV, and at best ½ the resolution of 3D Blu-ray discs.

Broadcast Sub-Category

Invasive Objects: Unwanted objects appear in the foreground, diverting attention from the action intended for the viewer. Invasive objects in a live broadcast are difficult to eliminate, and far more distracting in 3D than in 2D. It is annoying, but not fatal. Commonly objects rarely appear on screen for longer than a few seconds. They may include fans or flags in the crowd, players cutting abruptly in front of the action, cameras, coaches and staff, goalposts or rain.

Disappearances: Objects disappear in whole or in part

Graphic Focus: Graphics move too quickly across the screen for the viewer to see them properly

Graphic Placement: Graphics should appear coplanar with the stereo window, and should have convergence equal to 1. Objects should not be allowed to extend in front of the window to interfere with menus or subtitles, creating a physically impossible scene.

Brightness: Level of visible light of the broadcast to the viewer (nit value)

S3D Integrity Category

Sampling Time Offset: When capturing and playing back 60 fps stereoscopic video containing motion, there is a potential of a time offset between Left (L) and Right (R) eye views. This can be caused, for example, if L/R frames are sampled simultaneously and then played back sequentially instead of sampling L/R eye views sequentially and playing them back sequentially.

Window Violation: Objects appearing at the front of the window, where convergence is equal to 1, must stay a reasonable distance away from the edges of the window. Otherwise the brain gets conflicting messages due to rendering a physically impossible scene.

Vertical Misalignment: Tilting of the camera away from perfectly level causes vertical misalignment that must be corrected by cropping the captured video/image in both horizontal and vertical dimensions. This can cause extreme eye strain.

Horizontal Misalignment: Objects to appear on the surface of the stereo window should “snap” to a convergence of 1, while the rest of the scene should be shifted horizontally accordingly by the same amount.

Rotational Error: Left and right camera modules are inaccurately mounted such that they are not perfectly level with each other.

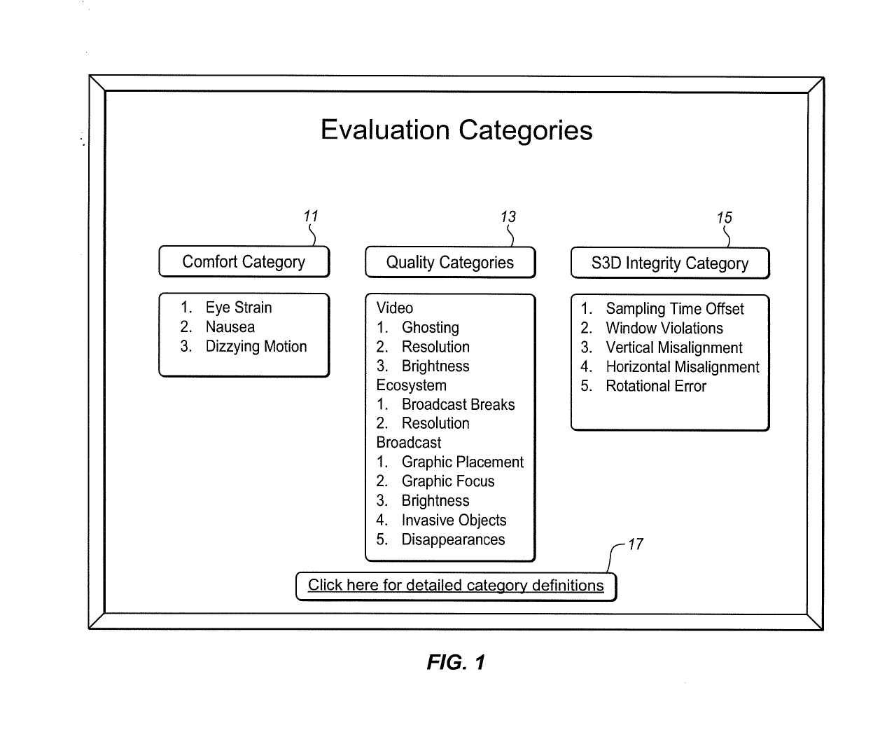

FIG. 1 shows an example of a presentation of scores that may be made according to the present invention. The presentation has each of the categories mentioned above, Comfort 11, Quality 13, and S3D Integrity 15. Under each category all of the factors are listed and numbered for easy reference. The Quality factors are each listed under respective subcategories as in Table 2 above. Such a presentation may be used as an introduction to allow a user to examine each category and factor individually. The various listings may be rendered as links to commands or data files that contain the relevant information for each item. Such a presentation may be made using a web browser, database, linked document or a variety of other presentation systems. A separate explanation link 17 is provided to aid in understanding the data presentation.

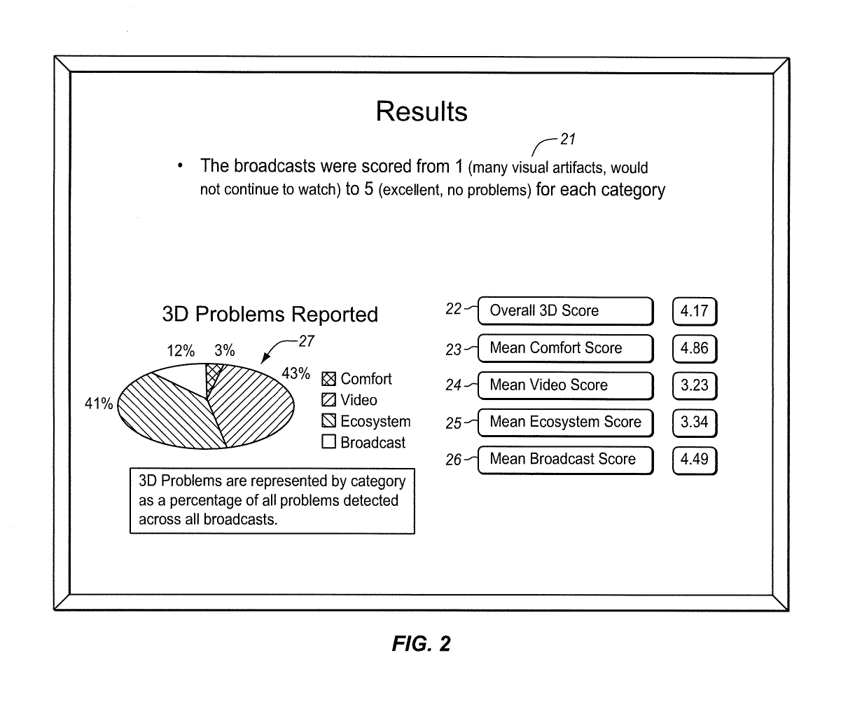

FIG. 2 shows a diagram of a presentation of results for a particular video. The video may be a broadcast S3D video or another 3D video. Such a presentation may be provided after a video has been analyzed. The presentation includes explanatory text 21, this may be eliminated or enhanced depending on the particular implementation. The text may also be provided as a link for the user to obtain additional information if desired. This illustrated text explains about using a scale from one to five as described in greater detail in the context of Table 1. Any scale may be used. A smaller scale allows for quicker scoring but may not allow for fine distinctions to be made.

The presentation also shows scores for each of the categories 23, 24, 25, 26 and an overall score 22. In this example, the scores are not integers from one to five but include values to the hundredths, such as 4.17. These values are obtained by determining an arithmetic mean of many scores determined during the length of the video. A higher or lower level of precision may be used for the scores and a different value other than a mean may be used. The scores may also be augmented with additional types of statistical evaluation such as averages, standard deviations, etc. The title bar for each score may be provided as a link that can be clicked or selected to provide more information about each score, such as the factors that went into it and further statistical analysis.

In addition to listing the scores, the presentation also includes a graphical representation of the scores. In this case a pie chart allows the quantity of different types of problems to be compared. Other types of graphical presentation may be used, such as bar charts, line graphs, histograms, etc. The pie shows that most of the problems were in the video category at 43% with the ecosystem problems close behind at 41%. To make the most significant improvement to the quality of the S3D video, the producers should focus on these two categories. Focusing on Comfort issues at 3% of reported problems would have very little effect on the quality in comparison. By reported problems, the system refers to detected errors, flaws, or negative scores. In an alternative embodiment, viewers may be enlisted to view the video and report problems in various categories and subcategories. In this case, the reported problems would refer to reports made by the viewers. Rather than enlisted viewers, consumers of the broadcast product, selected audience, or a natural audience may be used to generate problem reports.

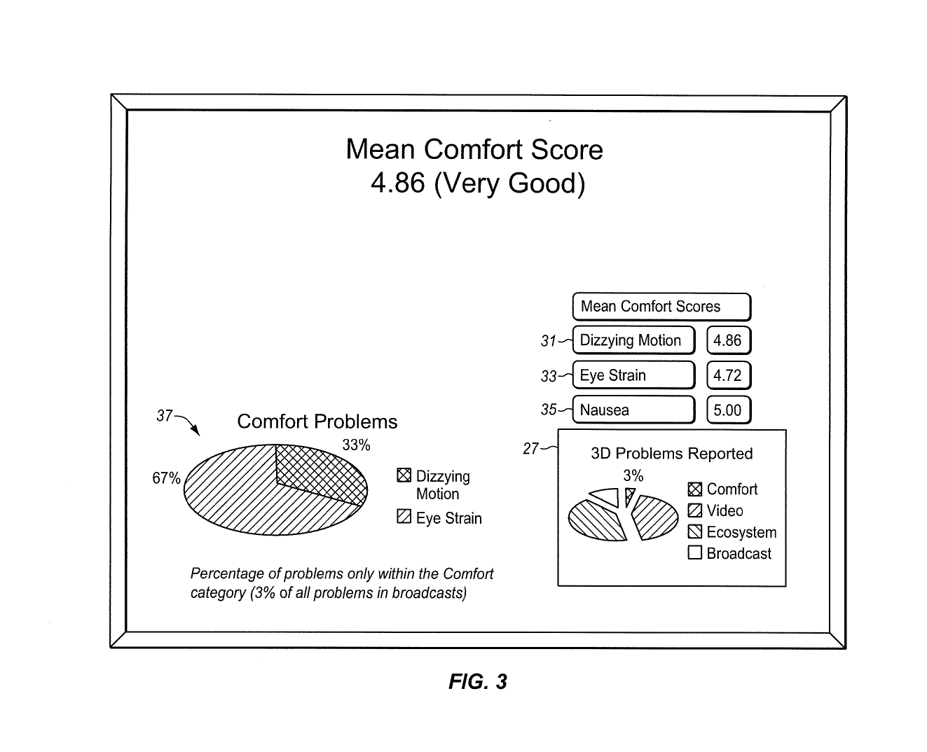

FIG. 3 shows a diagram of a presentation of the scores within only the Comfort category 23. This allows a breakdown of the mean score to be presented. Such a presentation may be reached by selecting or clicking on the Mean Comfort Score box 23 of the Overall presentation or in a variety of other and additional ways, depending on the implementation. The Comfort category presentation first provides the Mean Comfort Score, in this case 4.86 together with an adjective to characterize the overall score, in this case Very Good. The presentation also provides detailed scores for each factor 31, 33, 35 in the Comfort category. These may also be associated with descriptive adjectives (not shown). More or fewer factors may be used, depending on the particular application. Each factor has a score and the mean comfort score may be provided as the arithmetic mean of the three scores. In the present example, the mean comfort score of 4.86 is the average of the scores for each factor. The scores for each factor may also be mean scores over the entire length of the video or determined in any of a variety of other ways.

The Comfort Score presentation also provides a pie chart 37 of the comfort problems related to the three factors that are scored by the system. The pie chart is similar to that of FIG. 2 and the pie chart 27 of FIG. 2 is also presented for reference purposes. This allows the user to quickly be reminded of the significance of each category when considering each category in detail.

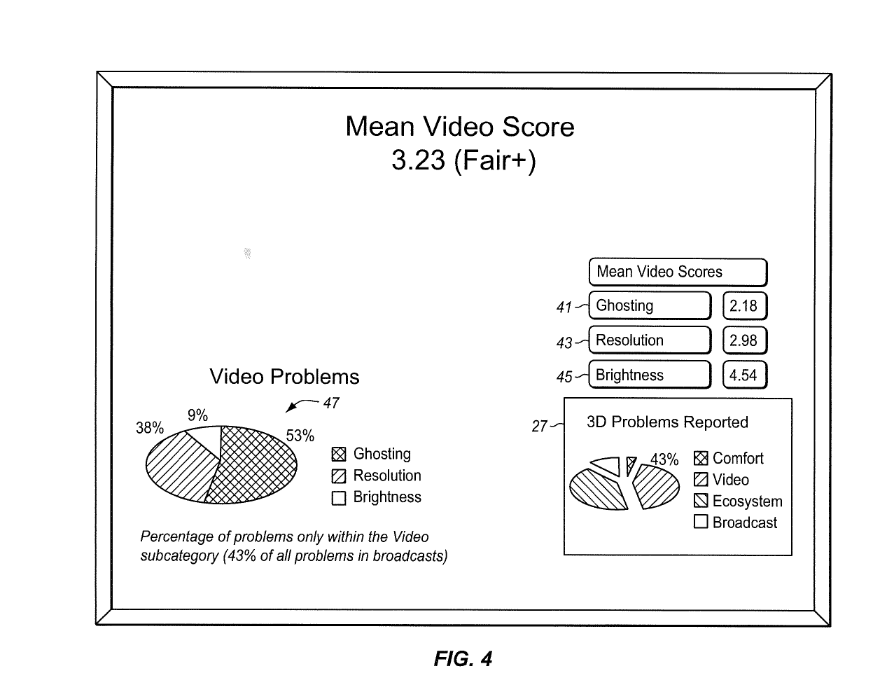

FIG. 4 shows a presentation of the Mean Video Score in the same manner as the Mean Comfort Score of FIG. 3. In this case, scores for the three video factors 41, 43, 45 are presented together with a pie chart 47 representation of the relative size of each score. The overall pie chart 27 is again included for reference.

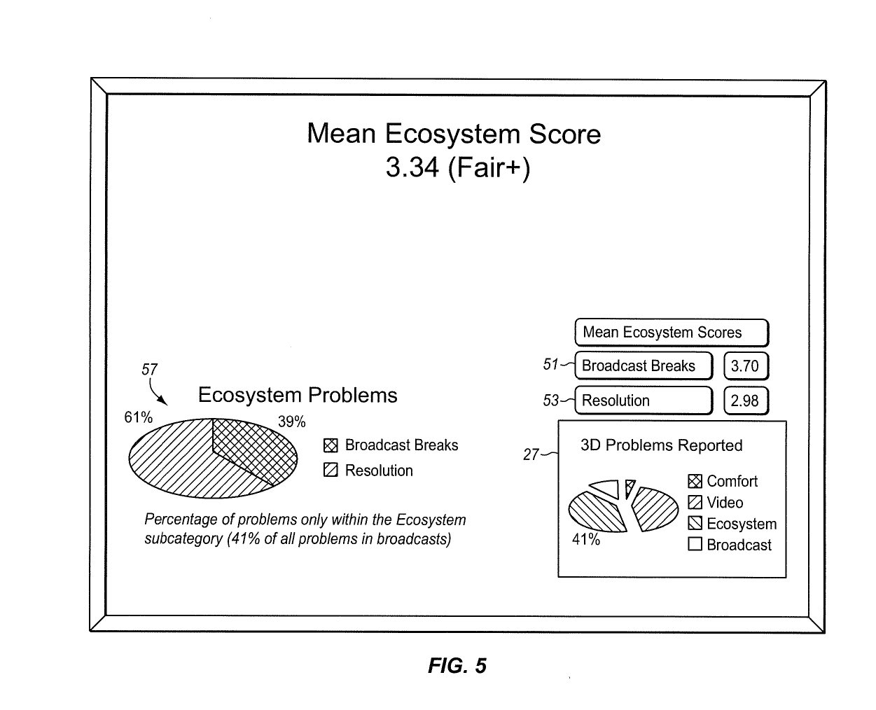

FIG. 5 shows a presentation of the Mean Ecosystem Score in the same manner as the Mean Comfort Score of FIG. 3. In this case, scores for the two Ecosystem factors 51, 53 are presented together with a pie chart 57 representation of the relative size of each score. The overall pie chart 27 is again included for reference.

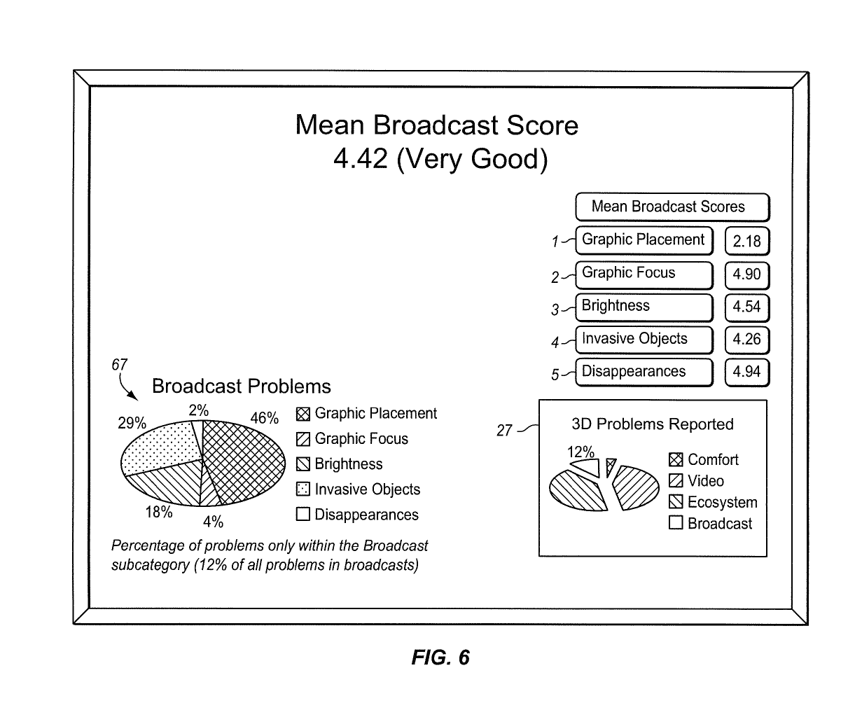

FIG. 6 shows a presentation of the Mean Broadcast Score in the same manner as the Mean Comfort Score of FIG. 3. In this case, scores for the five video factors 1, 3, 3, 4, 5 are presented together with a pie chart 7 representation of the relative size of each score. The overall pie chart 27 is again included for reference. It may be noted that Video, Ecosystem, and Broadcast are provided as subcategories within the Quality category. Accordingly a Quality category presentation may be made featuring overall subcategory scores and presented in a similar manner. A similar presentation may also be made for the S3D Integrity category using the same format as shown in FIGS. 3, 4, 5, and 6.

The scores determined as described above, allow a single video to be evaluated as it is broadcast and also after it is broadcast or produced using a stored version. The scores from 1 to 5 provide a quantifiable set of metrics that are normalized along the 1 to 5 scale. As mentioned above, the 1 to 5 scale is chosen for convenience and simplicity, any other numerical, alphabetical or other type of scale may be chosen, depending on the particular application of the system.

The quantifiable set of metrics also allows videos to be compared to each other. Table 3 shows an example of metrics that may be determined for a first video and a second video and using many of the factors mentioned above. The Table allows the two videos to be compared and shows, for example, that while ghosting was better for the second video, broadcast breaks was better for the first video. The videos may be compared and from these differences the quality of both videos may be improved. Table 3 also shows an overall score for each video and for the two videos combined, which, in this example, happens to be the same.

TABLE 3

| | | | | Dis- | Loss of | |
|---|---|---|---|---|---|---|
| | | Invasive | Dizzying | appear- | Graphic | Eye |
| | Ghosting | Objects | Motion | ances | Focus | Strain |
| 1st Video | 2.08 | 4.16 | 4.8 | 4.96 | 4.92 | 4.72 |
| 2nd Video | 2.28 | 4.36 | 4.92 | 4.92 | 4.88 | 4.72 |
| Overall | 2.18 | 4.26 | 4.86 | 4.94 | 4.9 | 4.72 |
| | | | Low | | | |
| | | Broadcast | Resolu- | Bright- | Graphic | |
| | Nausea | Breaks | tion | ness | Placement | Overall |
| 1st Half | 5 | 3.88 | 3 | 4.48 | 3.84 | 4.17 |
| 2nd Half | 5 | 3.52 | 2.96 | 4.6 | 3.8 | 4.17 |
| Overall | 5 | 3.7 | 2.98 | 4.54 | 3.82 | 4.17 |

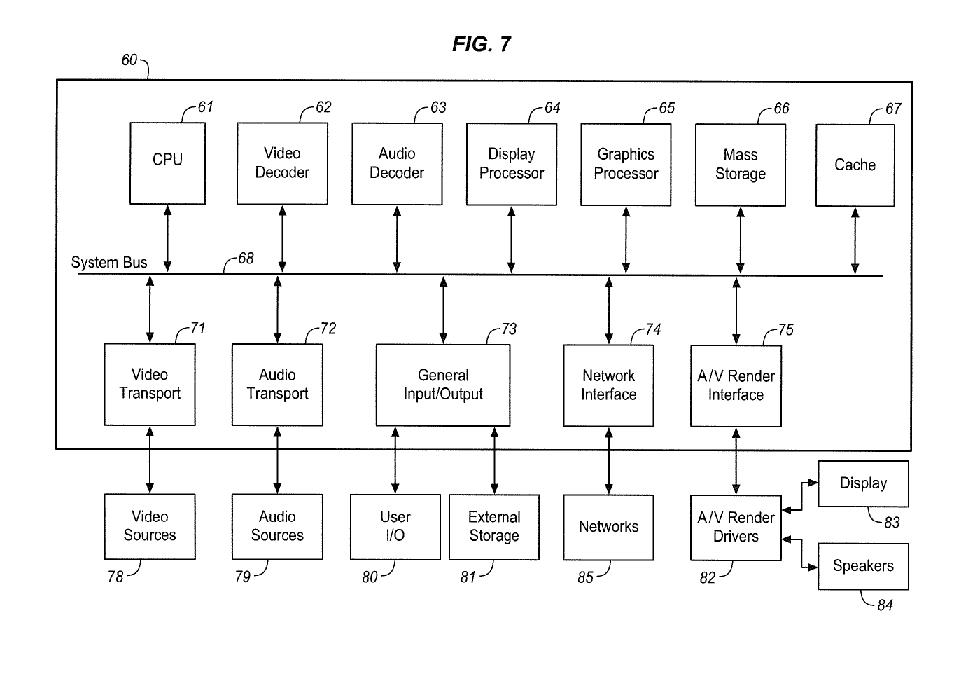

FIG. 7 is a block diagram of a television or set-top box implementing the techniques described above. The system uses an SOC 60 coupled to various peripheral devices and to a power source (not shown). The operations described above may be performed in a central processing resource of the system or in a specific dedicated processing resource. In this example, a CPU 61 of the SOC runs an OS stack and applications and is coupled to a system bus 68 within the SOC. The OS stack includes or interfaces with the pipeline manager executed by the CPU and are stored in a mass storage device 66 also coupled to the bus. The mass storage may be flash memory, disk memory or any other type of non-volatile memory. The OS, the pipeline manager, the applications, and various system and user parameters are stored there to be loaded when the system is started.

The SOC may also include additional hardware processing resources all connected through the system bus to perform specific repetitive tasks that may be assigned by the CPU. These include a video decoder 62 for decoding video in any of the streaming, storage, disk and camera formats that the set-top box is designed to support. An audio decoder 63 as described above decodes audio from any of a variety of different source formats, performs sample rate conversion, mixing, and encoding into other formats. The audio decoder may also apply surround sound or other audio effects to the received audio.

A display processor may be provided to perform video processing tasks such as de-interlacing, anti-aliasing, noise reduction, or format and resolution scaling. A graphics processor 65 may be coupled to the bus to perform shading, video overlay and mixing and to generate various graphics effects. The graphics processor may also be used to analyze the video to determine metrics for the Quality, Integrity and Comfort vectors as described above. All of the hardware processing resources and the CPU may also be coupled to a cache memory 67 such as DRAM (Dynamic Random Access Memory) or SRAM (Static RAM) for use in performing assigned tasks. Commands, instructions and vector metrics may be stored here before compile results are moved to mass storage 66. They may also each incorporate some amount of local cache. Each unit may also have internal registers for configuration, and for the short-term storage of instructions and variables.

A variety of different input and output interfaces may also be provided within the SOC and coupled through the system bus or through specific buses that operate using specific protocols suited for the particular type of data being communicated. A video transport 71 receives video from any of a variety of different video sources 78, such as tuners, external storage, disk players, internet sources, etc. An audio transport 72, receives audio from audio sources 79, such as tuners, players, external memory, and internet sources.

A general input/output block 73 is coupled to the system bus to connect to user interface devices 80, such as remote controls or controllers, keyboards, control panels, etc. and also to connect to other common data interfaces for external storage 81. The external storage may be smart cards, disk storage, flash storage, media players, or any other type of storage. Such devices may be used to provide media for playback, software applications, or operating system modifications.

A network interface 74 is coupled to the bus to allow connection to any of a variety of networks 85 including local area and wide area networks whether wired or wireless. Internet media and upgrades as well as communications may be provided through the network interface by providing data and instructions through the system bus. The network interface may also be used as a back channel for the communication of the compiled metrics and of remote commands to perform and conduct video analyses. The Bluetooth A2DP stack described above is fed through the network interface 74 to a Bluetooth radio 85. The video to be analyzed may also be received through the network interface 85 or through the video sources 78.

A display interface 75 is also coupled to the system bus 68 to provide analog or digital video output to a display driver 82. The display driver feeds a display 83 and speakers 84. Different video and audio sinks may be fed by the display driver. The display driver may be wired or wireless. For example, instead of using the network interface for a Bluetooth radio interface, the display driver may be used to send wireless Bluetooth audio to a remote speaker. The display driver may also be used to send WiDi (Wireless Display) video wirelessly to a remote display.

A lesser or more equipped system than the example described above may be preferred for certain implementations. Therefore, the configuration of the exemplary system on a chip and set-top box will vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

In embodiments, the invention may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

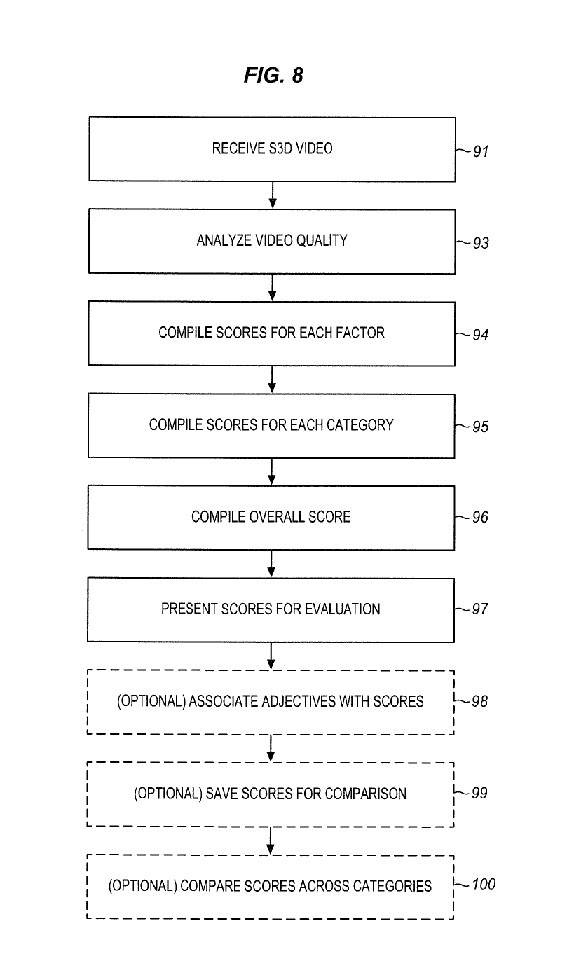

FIG. 8 is a process flow diagram showing techniques described above for estimating the quality of a video. At 91 a stereoscopic three-dimensional video is received at a processor or some other device for evaluation. At 92 the video is analyzed for quality. As described above, the video is compared against an established set of factors in different categories that affect the presentation of the video. The evaluation may be made in any of a variety of different ways using video evaluation and frame analysis tools that may be implemented in hardware or software. In some cases, basic properties of the videos such as resolution, frame rate, audio track type and other types of factors may also be evaluated.

At 94, the scores for each factor are compiled. At 95 the factor scores are compiled into scores for each category. There may be one or more categories. In the described example, such as in Table 2, there are three categories and one of the categories has three subcategories. The number of factors may be the same or as in Table 2 different, depending on the category. While the particular factors and categories described herein have been found to be particularly useful for S3D live broadcast evaluation, factors may be added or removed and re-categorized to suit particular applications.

At 95, the overall scores are compiled from the scores for the categories into an overall three-dimensional score and at 97; the scores are presented for evaluation. The presentation may take the form shown in FIGS. 1 to 6 or in Table 3 or in any other form.

FIG. 8 also include some optional operations that may be performed to suit particular applications. Any one or more of these operations may be added or deleted from the process to suit a particular application. At 98, adjectives are associated with the scores for each category. This may be used to aid a user in understanding the quantified metrics provided by the scores. At 99, the scores may be saved for comparison with later or similar other S3D videos or with other materials. Such a comparison is shown, for example, in Table 3. The saved metrics may then be used for evaluation against metrics for other videos.

At 100, the scores are compared across categories. The comparison may then be presented for evaluation. In the examples above, pie charts were presented to compare different scores from different categories and to compare different scores from different factors within the same category.

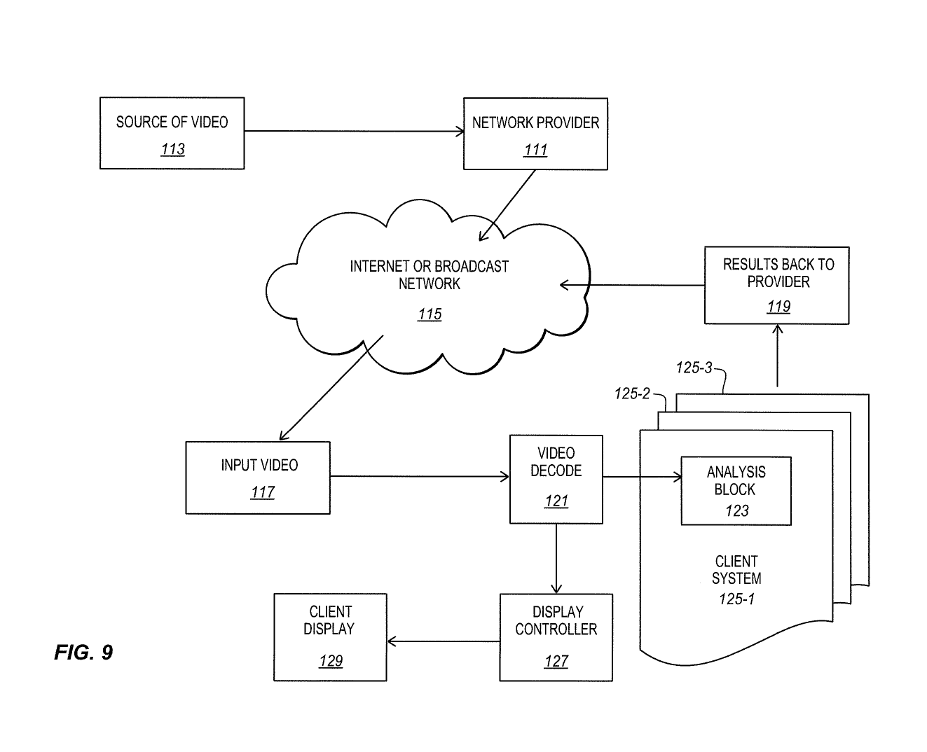

FIG. 9 shows a system implementation of the techniques described above. The diagram shows that incoming video is decoded and then analyzed using hardware or software resources in a video production and distribution chain. In this example, resources at client devices compute factors for the three categories, quality, integrity, and comfort and feed those metrics back to the provider. The provider can then use these metrics to aid in fixing or improving the S3D video experience. This is particularly valuable in the context of live broadcast video for which unpredictable problems may arise, however, the invention is not so limited.

In the distribution network of FIG. 9, a network provider 111, such as a television or internet channel 11 receives video from a source 113. The source may be its own news, sports, or production team or an independent content provider. In the example above, the video is live S3D video. The video is sent through an internet or broadcast medium 115, such as cable, satellite, or terrestrial radio broadcast to a client 125-1, such as a home or institutional viewer. While 3 clients are shown there may be many hundreds or millions.

The client device 125 receives and decodes the video in a decoder 121 and analyzes it for quality factors in an analysis block 123 as described above. The analysis may be done in hardware, software, or firmware. The video is then provided to a display controller 127 to be presented to the client on a display 129. The client may also be invited to provide an analysis after or during the video. Questions may be presented to the client on the display 129 and the client may respond using the client systems user interface, such as a remote control. The questions may ask for subjective opinions or may be asked for objective comparisons regarding the quality of the presented video or whether the client enjoyed the video.

The results 119 determined in the analysis block are provided back to the provider 111 through the network 115. The results may be shared with the broadcaster and the video source. In the illustrated example, the video is received through a broadcast connection, such as satellite or cable and returned through a point-to-point connection, such as the internet. However, some broadcast systems offer a return channel and some point-to-point systems offer a multicast or broadcast function, so the same or a different channel may be used depending on the application.

While the analysis is shown as being performed and sent back through a client device 125, the same or similar analyses may be performed at the video source 113, at the network provider 111 or by the broadcaster 115. These analyses may be instead of or in addition to the client analysis.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
receiving a stereoscopic three-dimensional video at a processor;
analyzing the video for a plurality of factors in a plurality of categories that affect the presentation of the video;
compiling scores for each factor into scores for a category;
compiling scores for the category into an overall three-dimensional score; and
presenting the scores for evaluation.

2. The method of claim 1, further comprising associating adjectives with the scores for each category.

3. The method of claim 1, wherein the scores comprise a quantifiable set of metrics.

4. The method of claim 3, wherein the scores are applied to a normalized uniform scale.

5. The method of claim 4, wherein the scale is from one to five.

6. The method of claim 3, wherein the metrics are saved for evaluation against metrics for other videos.

7. The method of claim 1, further comprising comparing scores across categories and presenting the comparison for evaluation.

8. The method of claim 1, wherein the categories are associated with a source affecting the score.

9. The method of claim 1, wherein one category relates to the quality of the video as presented and affected by factors aggregated along different points in a video production and broadcast chain.

10. The method of claim 1, wherein one category relates to integrity of the three-dimensional aspects of the video.

11. The method of claim 1, wherein one category relates to viewer physical comfort when viewing a presentation of the video.

12. An apparatus comprising:
a video transport to receive a stereoscopic three-dimensional video from an outside source;
a video decoder to decode the video for use within the apparatus;
a graphics processor to analyze the video for a plurality of factors in a plurality of categories that affect the presentation of the video;
a general processor to compile the scores for each factor into scores for a category and to compile scores for the category into an overall three-dimensional score; and
an external interface to present the scores for evaluation.

13. The apparatus of claim 12, wherein the graphics processor and the general processor are the same processor.

14. The apparatus of claim 12, wherein the external interface comprises a display interface to present a visual representation of the scores.

15. The apparatus of claim 12, further comprising a mass storage device to store the compiled scores.

16. A machine-readable medium having instructions that when executed by the machine cause the machine to perform operations comprising:
receiving a stereoscopic three-dimensional video at a processor;
analyzing the video for a plurality of factors in a plurality of categories that affect the presentation of the video;
compiling scores for each factor into scores for a category;
compiling scores for the category into an overall three-dimensional score; and
presenting the scores for evaluation.

17. The medium of claim 16, the operations further comprising associating adjectives with the scores for each category.

18. The medium of claim 16, the operations further comprising comparing scores across categories and presenting the comparison for evaluation.

19. An apparatus comprising:
a video tuner to receive a stereoscopic three-dimensional video from an outside source;
a video decoder to decode the video for use within the apparatus;
a graphics processor to analyze the video for a plurality of factors in a plurality of categories that affect the presentation of the video;
a general processor to compile the scores for each factor into scores for a category and to compile scores for the category into an overall three-dimensional score;
a mass storage device to store the compiled scores;
a network interface to send the scores to the outside source for evaluation; and
a display to render the video to a local user.

20. The apparatus of claim 19, further comprising a user input device to receive quality scores from a viewer of the video on the display.
